(19) United States
(12) Patent Application Publication
(10) Pub. No.: US 2026/0106272 A1
(43) Pub. Date: Apr. 16, 2026

(54) Cell Pouch Folding Jig

(71) Applicant: LG Energy Solution, Ltd., Seoul (KR)

(72) Inventors: Gabhyung KIM, Troy, MI (US); Junyoug PARK, Holland, MI (US); Soojun AHN, Byron Center, MI (US); Taewook KIM, Jenison, MI (US)

(73) Assignee: LG Energy Solution, Ltd., Seoul (KR)

(21) Appl. No.: 18/913,549

(22) Filed: Oct. 11, 2024

(51) Int. Cl. H01M 50/105; B21D 5/16

(52) U.S. Cl. CPC H01M 50/105; B21D 5/16

(57) ABSTRACT

A cell pouch folding jig assembly for folding the corners of a pouch of a battery cell pouch includes a base jig having a flat base, a pair of sidewalls extending from side edges of the flat base, a folding platform disposed at an end of the flat base and a guide structure having a pair of exterior pressing block guide slots extending laterally outward from the folding platform. A pair of pressing blocks are received in the pair of exterior pressing block guide slots and are movable laterally inward to engage the corners of the pouch. The pair of pressing blocks each include a tapered tip.

### FIELD

Aspects of the present disclosure relate to a cell pouch folding jig and related systems and methods thereof.

### BACKGROUND

This section provides background information related to the present disclosure which is not necessarily prior art.

Battery cells have taken on several forms including, but not limited to cylindrical cells, prismatic cells and pouch cells. A pouch-type battery cell is a type of lithium-ion battery design that differs from the more common cylindrical and prismatic formats. Pouch cells do not have a rigid metal casing like cylindrical or prismatic cells. Instead, they use a sealed flexible foil as the cell container. The cell components (anode, cathode, and separator) are enclosed in an aluminum-coated plastic film. Only two tabs extend from the pouch, each welded to current collectors. These tabs serve as the positive and negative connectors, allowing electric energy to flow in and out of the cell. Pouch cells are lighter than their counterparts due to the absence of a metal casing. The pouch design allows cells to easily fit the available space within a product. Pouch cells can experience swelling with gas during charge and discharge, which affects their shape and volume. While cylindrical cells have lower packaging density, pouch cells can utilize available space more efficiently. Cooling and heating systems for pouch cell packs are relatively straightforward due to the space cavities that allow coolant circulation around the cells. In summary, pouch cells offer flexibility, lightweight design, and efficient space utilization. They are commonly used in portable electronic devices, electric vehicles, energy storage systems, etc. where weight and form factor may matter.

In the manufacture of cell pouches, the anode, the cathode and the separator are inserted into an open end of the pouch and the opening of the pouch is folded and sealed shut. Battery cells are encapsulated in pouches that can sometimes have aspects that flare or protrude, leading to assembly issues in battery packs. These protrusions can also interfere with other components during assembly, causing defects or damaging the battery. Currently, manual adjustments are made to correct these protrusions, but this method is inconsistent and prone to human error. There is a clear need for a standardized, reliable method to correct these protrusions to ensure consistent quality and reduce the risk of assembly interference.

### SUMMARY

This section provides a general summary of the disclosure, and is not a comprehensive disclosure of its full scope or all of its features.

According to an aspect of the present disclosure, a cell pouch folding jig assembly for folding the corners of a pouch of a battery cell pouch includes a base jig having a flat base, a pair of sidewalls extending from side edges of the flat base, a folding platform disposed at an end of the flat base and a guide structure having a pair of exterior pressing block guide slots extending laterally outward from the folding platform. A pair of pressing blocks are received in the pair of exterior pressing block guide slots and are movable laterally inward to engage the corners of the pouch. The pair of pressing blocks each include a tapered tip.

According to further aspect of the present disclosure, the pair of exterior pressing block guide slots each include a pair of opposing rails.

According to further aspect of the present disclosure, the pressing blocks each include a pair of recessed guide slots in opposite sides thereof that slidably receive the pair of opposing rails of the pair of exterior pressing block guide slots.

According to further aspect of the present disclosure, the tapered tip is angled at an angle of between 50° and 70° from a sidewall of the pair of pressing blocks.

According to further aspect of the present disclosure, the tapered tip is angled at approximately 60° from the sidewall.

According to further aspect of the present disclosure, as the pressing blocks are pressed laterally inward along the exterior pressing block guide slots, a long end of the tapered tip engages the distal corner of the pouch and folds the pouch corner diagonally inward.

According to further aspect of the present disclosure, a pair of inner pressing blocks that engage an open end of the pouch and inner side of the corners.

According to further aspect of the present disclosure, a pair of inner pressing blocks disposed against the pouch seam and moved laterally outward while the exterior pressing blocks are moved laterally inward to create a fold of the pouch corners over top of the inner pressing blocks.

According to further aspect of the present disclosure, the pair of inner pressing blocks have an engagement surface that is angled between 20° to 50° between the pouch engagement surface and a bottom surface of the inner pressing blocks.

According to further aspect of the present disclosure, the pair of inner pressing blocks have a pouch engagement surface that is angled at approximately 40° between the engagement surface and a bottom surface of the inner pressing blocks.

According to further aspect of the present disclosure, the exterior pressing blocks have a pouch engagement surface that is angled between 20° to 50° between the pouch engagement surface and a top surface of the exterior pressing blocks.

According to further aspect of the present disclosure, the pair of exterior pressing blocks have a pouch engagement surface that is angled at approximately 40° between the engagement surface and a top surface of the exterior pressing blocks.

According to further aspect of the present disclosure, an upper jig configured to engage the folded upper seam of the pouch above the folding platform to seal the upper seam closed.

According to another aspect of the present disclosure, a method of forming a cell pouch includes placing a cell pouch on a cell pouch folding jig with an upper seam placed between a pair of exterior pressing blocks. The pair of exterior pressing blocks are slid together to engage corners of the cell pouch and folding the corners of the pouch inward.

According to further aspect of the present disclosure, the a placing a pair of inner pressing blocks on top of the upper seam and the sliding the pair of exterior blocks together causes the corners of the cell pouch to be folded overtop of the pair of inner pressing blocks.

According to further aspect of the present disclosure, the pair of exterior pressing blocks each include a tapered tip.

According to further aspect of the present disclosure, the tapered tip is angled at an angle of between 50° and 70° from a sidewall of the pair of exterior pressing blocks.

According to further aspect of the present disclosure, as the pressing blocks are pressed laterally inward along the exterior pressing block guide slots, a long end of the tapered tip engages a corner of the pouch and folds the pouch corner diagonally inward.

According to further aspects of the present disclosure, the pair of inner pressing blocks have an engagement surface that is angled between 20° to 50° between the pouch engagement surface and a bottom surface of the inner pressing blocks.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a plan view of a cell pouch on a cell pouch folding jig according to the principles of the present disclosure;

FIG. 2 is a schematic view of the cell pouch on a cell pouch folding jig with pressing blocks folding the corners according to the principles of the present disclosure;

FIG. 3 is a perspective view of a base jig for the cell pouch folding jig according to the principles of the present disclosure;

FIG. 4 is an exploded perspective view of the cell pouch folding jig according to the principles of the present disclosure;

FIG. 5A is a perspective view of an outer pressing block according to the principles of the present disclosure;

FIG. 5B is a plan view of the outer pressing block according to the principles of the present disclosure;

FIG. 5C is end view of an outer pressing block according to the principles of the present disclosure;

FIG. 6 is a schematic view of the inner and outer pressing blocks engaging the corner of the cell pouch according to the principles of the present disclosure;

FIG. 7 is a detailed schematic view of the inner and outer pressing blocks engaging the corner of the cell pouch according to the principles of the present disclosure;

FIGS. 8A-8E show a progression of the engagement of the inner and outer pressing blocks engaging the corner of the cell pouch according to the principles of the present disclosure;

Corresponding reference numerals indicate corresponding parts throughout the several views of the drawings.

### DETAILED DESCRIPTION

Example embodiments will now be described more fully with reference to the accompanying drawings. Wherever possible, the same or similar reference numbers will be used throughout the drawings to refer to the same or like parts. Embodiments of the disclosure may solve one or more of the limitations in the art. The scope of the disclosure, however, is defined by the attached claims and not the ability to solve a specific problem.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms "a,” "an," and "the" may be intended to include the plural forms as well, unless the context clearly indicates otherwise. The terms "comprises," "comprising," “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being "on," “engaged to,” "connected to," or "coupled to" another element or layer, it may be directly on, engaged, connected or coupled to the other element or layer, or intervening elements or layers may be present. In contrast, when an element is referred to as being "directly on," “directly engaged to,” "directly connected to," or "directly coupled to" another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term "and/or" includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” "beneath," "below," "lower," "above," "upper," and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as "below" or "beneath" other elements or features would then be oriented "above" the other elements or features. Thus, the example term "below" can encompass both an orientation of above and below. The device may be otherwise oriented (rotated 90 degrees or at other orientations) and the spatially relative descriptors used herein interpreted accordingly.

In this disclosure, relative terms, such as, for example, “about,” “substantially,” “generally,” and “approximately” are used to indicate a possible variation of ±10% in a stated value or characteristic.

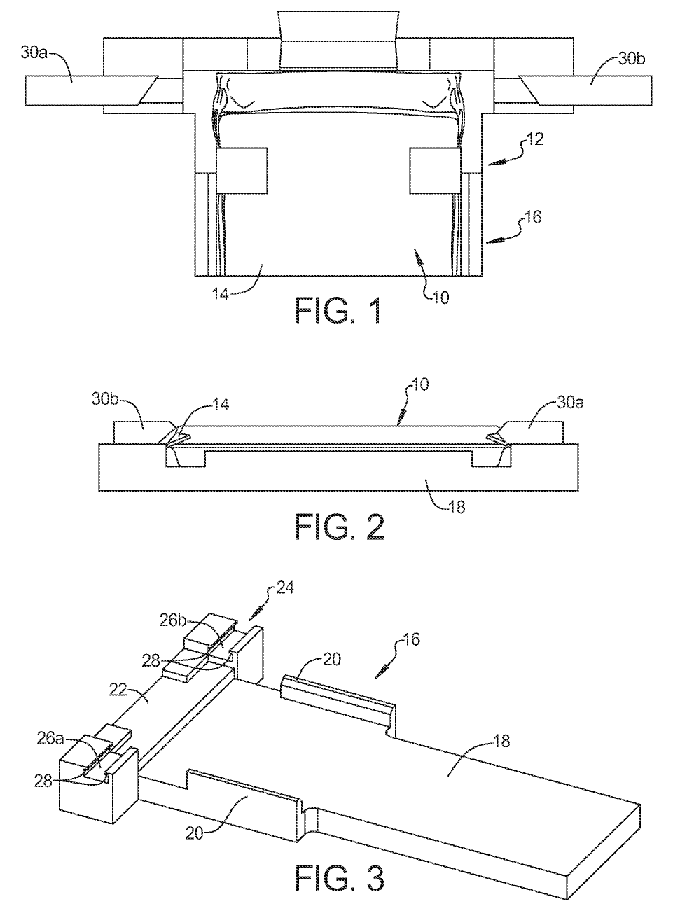

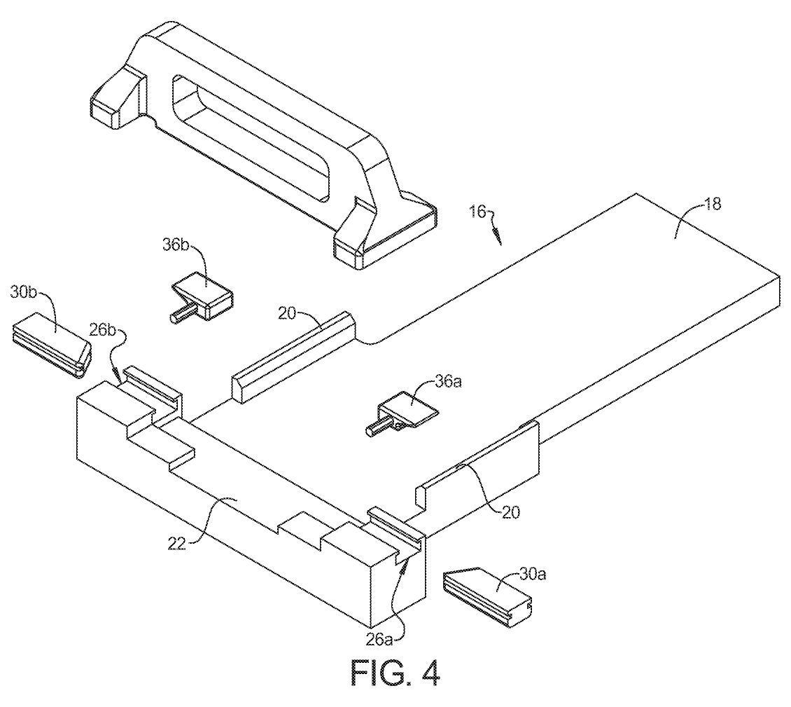

With reference to FIG. 1 a cell pouch assembly 10 is shown on a cell pouch folding jig assembly 12 according to the principles of the present disclosure. The cell pouch assembly 10 typically includes an anode, a cathode, and/or a separator all enclosed in a pouch 14. In some instances, pouch 14 may be an aluminum-coated plastic film, but is not necessarily limited thereto. The cell pouch assembly 10 includes front and back pouch panels that come together and form a seam around the perimeter of the pouch cell assembly 10 that are either heat sealed or sealed with an adhesive. With reference to FIGS. 3 and 4, the cell pouch folding jig assembly 12 includes a base jig 16 having a flat base 18. The flat base 18 is sized to receive a cell pouch. For example, typical cell pouches have a width of 99.2 cm and 102.2cm.

A pair of sidewalls 20 extend along opposite sides of the flat base 18. The pair of sidewalls 20 are spaced at an approximate width of the cell pouch and have a height sufficient to secure the cell pouch within the jig assembly 10 during a folding process. An interior surface of the pair of sidewalls 20 can have a beveled upper edge 20a for guiding the cell pouch to a centered position between the sidewalls 20. A length of the sidewalls 20 needs to be sufficient to hold the cell pouch assembly 10 in place during folding of the corners. The length of the sidewalls 20 can be less than or equal to a length of the flat base. The sidewalls to can be formed integral with the flat base 18 or can be attached thereto. A length of the flat base 18 can be sized to receive all or part of the cell pouch thereon. For example, typical cell pouches have a length of between 300cm and 302cm. A folding platform 22 is provided at one end of the flat base 18 and is stepped upward with respect to the flat base 18. The folding platform 22 can be stepped upward from the flat base by a distance that can be approximately equal to one half a thickness of the cell pouch so that a centered seam of the cell pouch rests flat on the folding platform 22. A height of the folding platform 22 can be chosen based upon a seam location along a width of the cell pouch. For example, typical cell pouches have thickness of between 8 cm and 11 cm. Accordingly, the stepped platform 22 can be stepped upward from the flat base 18 by a distance of between 4 cm and 5.5cm. A width of the flat base can be narrowed at an end opposite the folding platform to allow for easier access of the user’s fingers underneath a cell pouch received on the jig assembly 10 for cell pouch placement and removal. The base jig 16 can be made from plastic, wood, metal or other materials. The flat base 18 can be provided with additional layers of padding to assist in holding the cell pouch 10 during a folding operation.

A guide structure 24 includes a pair of exterior pressing block guide slots 26a, 26b that extend laterally outward from opposite sides of the folding platform 22. The guide structure 24 can be integrally formed with the flat base 18 or attached thereto. The pair of exterior pressing block guide slots 26a, 26b each include a pair of opposing rails 28. The opposed rails 28 protrude inward toward one another along a top edge of the exterior pressing block guide slots 26a, 26b.

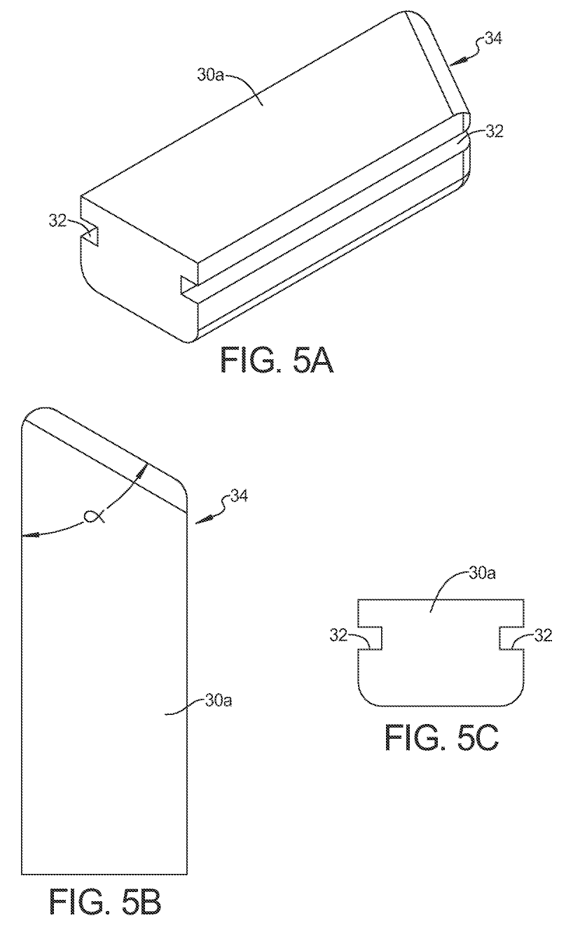

With reference to FIG. 1, a pair of pressing blocks 30a, 30b are received in the pair of exterior pressing block guide slots 26a, 26b and are movable laterally inward to engage protruding aspects, e.g., the corners, of pouch 14. With reference to FIGS. 5A-5C, the pressing blocks 30a, 30b each include a pair of recessed guide slots 32 in opposite side surfaces thereof, as best seen in FIG. 5C. The recessed guide slots 32 each slidably receive the pair of opposing rails 28 of the pair of exterior pressing block guide slots 26a, 26b. The pair of pressing blocks 30a, 30b each include a tapered tip 34 so that a side of the pressing blocks 30a, 30b that is distal from the flat base 18 is longer than the side of the pressing blocks 30a, 30b that is proximal the flat base 18. The tapered tip 34 is angled at a taper angle α of between 50° and 70° from the sidewall of the pair of pressing blocks as illustrated in FIG. 5B, although other taper angles can be used. In the embodiment shown, the tapered tip is angled at 60° from the sidewall. The taper angle α generally dictates the angle at which the pouch corner is folded inward and therefore can be any angle that achieves a desired fold. It is noted that the pressing block 30a shown in FIGS. 5A-5C is a mirror image of the pressing block 30b, not shown therein.

As shown in FIG. 1, as the pressing blocks 30a, 30b are pressed laterally inward along the exterior pressing block guide slots 26a, 26b, the long end of the tapered tip 34 engages the distal corner of the pouch 14 and folds the pouch corner diagonally inward as shown in FIG. 2. The folding of the corners is done until they are folded based upon a visual inspection.

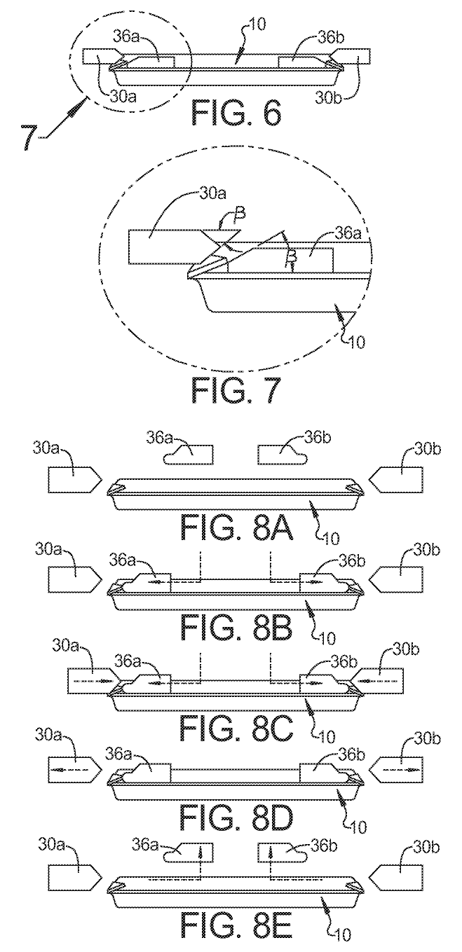

With reference to FIGS. 6-8, a pair of optional inner pressing blocks 36a, 36b are shown used in combination with the pair of exterior pressing blocks 30a, 30b. The inner pressing blocks 36a, 36b have a 3.5 mm step for allowing overlap with the exterior pressing blocks. The cell is manually folded using the inner pressing blocks 36a, 36b and the exterior pressing blocks 30a, 30b. As shown in FIG. 8A the inner pressing blocks 36a, 36b are supported above the pouch seam and the exterior pressing blocks 30a, 30b are retracted laterally outward. As shown in FIG. 8B the inner pressing blocks 36a, 36b are brought down against the pouch seam and moved laterally outward and the exterior pressing blocks 30a, 30b remain retracted laterally outward. As shown in FIG. 8C, the exterior pressing blocks 30a, 30b are then moved laterally inward to create a proper fold of the pouch corners over top of the inner pressing blocks 36a, 36b. As shown in FIG. 8D, the exterior pressing blocks 30a, 30b are then moved laterally outward and in FIG. 8E, the inner pressing blocks are retracted laterally inward and away from the pouch seam.

With reference to FIG. 4 an upper jig 34 is placed above the folded upper seam and seals the upper seam closed. The upper jig 34 can apply heat and/or pressing for sealing the upper seam closed.

With reference to FIGS. 6 and 7, the inner pressing blocks 36a, 36b and the exterior pressing blocks 30a, 30b are shown engaging the corner of the cell pouch according to the principles of the present disclosure. As shown in FIG. 7, an upper engagement surface 38 of the inner pressing blocks 36a, 36b can have an angle β of between 20° to 50° between the engagement surface 38 and a bottom surface 40 of the inner pressing blocks 36a, 36b. In the embodiment shown, the angle β is 40°. The bottom engagement surface 42 of the exterior pressing blocks 30a, 30b can have the same angle β of between 20° and 50° between the angled bottom engagement surface 42 and the top surface of the exterior pressing blocks 30a, 30b.

The exterior pressing blocks 30a, 30b press the protruding corner of the pouch to remove the protruding part. The angles α and β of the engagement surfaces 38, 42 inner pressing blocks 36a, 36b and the exterior pressing blocks 30a, 30b can be chosen to provide a proper fold at the corner of the pouch 14 based upon different cell pouch shapes, sizes and pouch opening designs.

The cell pouch folding jig assembly 12 is specifically designed to address the problem of exposed cell pouches by precisely folding the cell pouch corners before assembly into the cartridge.

The present disclosure introduces a mechanical solution to fold and correct cell pouch protrusions automatically before assembly. The present disclosure provides a precise, mechanized solution that ensures uniformity in correcting pouch protrusions. It is capable of adjusting to various pouch sizes and shapes, making it versatile for different cell types. This automation not only improves assembly efficiency but also significantly reduces the risk of battery pack defects.

The cell pouch folding tool automatically adjusts the flared areas of cell pouches using a press jig with side pushers before the cell assembly process. By applying a specific step to the cell corners, it ensures that protrusions are folded to a uniform dimension, reducing the risk of interference during assembly. This process is both standardized and repeatable, minimizing the potential for defects related to manual rework.

The above description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An assembly, comprising:
a base jig having a flat base, a pair of sidewalls extending from side edges of the flat base, a folding platform disposed at an end of the flat base, a guide structure having a pair of exterior pressing block guide slots extending laterally outward from the folding platform; and
a pair of pressing blocks are received in the pair of exterior pressing block guide slots and are movable laterally inward to engage corners of a battery cell, wherein the pair of exterior pressing blocks each include a tapered tip.

2. The assembly according to claim 1, wherein the pair of exterior pressing block guide slots each include a pair of opposing rails.

3. The assembly according to claim 2, wherein the pressing blocks each include a pair of recessed guide slots in opposite sides thereof that slidably receive the pair of opposing rails of the pair of exterior pressing block guide slots.

4. The assembly according to claim 1, wherein the tapered tip is angled at an angle of between 50° and 70° from a sidewall of the pair of exterior pressing blocks.

5. The assembly according to claim 1, wherein the tapered tip is angled at approximately 60° from a sidewall of the pressing blocks.

6. The assembly according to claim 4, wherein as the pressing blocks are pressed laterally inward along the exterior pressing block guide slots, a long end of the tapered tip engages a corner of the pouch and folds the pouch corner diagonally inward. wherein as the pressing blocks are pressed laterally inward along the exterior pressing block guide slots, a long end of the tapered tip engages a corner of the pouch and folds the pouch corner diagonally inward.

7. The assembly according to claim 1, further comprising a pair of inner pressing blocks that engage an open end of the pouch and inner side of the corners.

8. The assembly according to claim 1, further comprising a pair of inner pressing blocks disposed against a pouch seam and moved laterally outward while the exterior pressing blocks are moved laterally inward to create a fold of the pouch corners over top of the inner pressing blocks.

9. The assembly according to claim 8, wherein the pair of inner pressing blocks have an engagement surface that is angled between 20° to 50° between the pouch engagement surface and a bottom surface of the inner pressing blocks.

10. The assembly according to claim 8, wherein the pair of inner pressing blocks have a pouch engagement surface that is angled at approximately 40° between the engagement surface and a bottom surface of the inner pressing blocks.

11. The assembly according to claim 8, wherein the exterior pressing blocks have a pouch engagement surface that is angled between 20° to 50° between the pouch engagement surface and a top surface of the exterior pressing blocks.

12. The assembly according to claim 8, wherein the pair of exterior pressing blocks have a pouch engagement surface that is angled at approximately 40° between the engagement surface and a top surface of the exterior pressing blocks.

13. The assembly according to claim 1, further comprising an upper jig configured to engage a folded upper seam of the pouch above the folding platform to seal the upper seam closed.

14. A method of forming a cell pouch comprising;
placing a cell pouch on a cell pouch folding jig with an upper seam placed between a pair of exterior pressing blocks; and
sliding the pair of exterior pressing blocks together to engage corners of the cell pouch and folding the corners of the pouch inward.

15. The method of forming a cell pouch according to claim 14, further comprising a placing a pair of inner pressing blocks on top of the upper seam and the sliding the pair of exterior blocks together causes the corners of the cell pouch to be folded overtop of the pair of inner pressing blocks.

16. The method of forming a cell pouch according to claim 14, wherein the pair of exterior pressing blocks each include a tapered tip.

17. The method of forming a cell pouch according to claim 16, wherein the tapered tip is angled at an angle of between 50° and 70° from a sidewall of the pair of exterior pressing blocks.

18. The method of forming a cell pouch according to claim 17, wherein as the pressing blocks are pressed laterally inward along the exterior pressing block guide slots, a long end of the tapered tip engages a corner of the pouch and folds the pouch corner diagonally inward.

19. The method of forming a cell pouch according to claim 18, wherein the pair of inner pressing blocks have an engagement surface that is angled between 20° to 50° between the pouch engagement surface and a bottom surface of the inner pressing blocks.
